(19) United States
(12) Patent Application Publication
(10) Pub. No.: US 2016/0025857 A1
(43) Pub. Date: Jan. 28, 2016

(54) GEOLOCATION DEVICE

(71) Applicant: THALES, Courbevoie (FR)

(72) Inventors: Bruno MONTAGNE, VALENCE (FR); Franck LETESTU, VALENCE (FR)

(21) Appl. No.: 14/809,011

(22) Filed: Jul. 24, 2015

(30) Foreign Application Priority Data
Jul. 24, 2014 (FR) 14 01698

(51) Int. Cl. G01S 19/01; G01S 19/21

(52) U.S. Cl. CPC G01S 19/015; G01S 19/215

(57) ABSTRACT

A geolocation device is disclosed. In one aspect, the geolocation device is adapted for receiving first radioelectric positioning signals from satellites. Each first signal has a first frequency and is generated from a first code specific to the satellite, from which stems the first signal. The device includes a first antenna configured to receive a geolocation signal, and a processing unit configured to determine a piece of positioning information of the device according to the geolocation signal which the first antenna is configured to receive. The device also includes a second antenna configured to emit at least one second signal, each second signal either being an emitted jamming signal, or an emitted spoofing signal and having a jamming or spoofing frequency spectrum including at least one of the first frequencies.

### CROSS-REFERENCE TO RELATED APPLICATIONS

This application claims benefit under 35 U.S.C. §119 of French Application No. 14 01698, filed Jul. 24, 2014, which is herein incorporated by reference in its entirety.

### BACKGROUND

1. Technological Field

The described technology generally relates an adapted geolocation device for determining at least one piece of information relating to its geographic positioning, i.e., to the positioning of the geolocation device. More specifically, the geolocation device is adapted for receiving first radioelectric positioning signals transmitted by satellites. The geolocation device comprises an antenna for receiving a geolocation signal comprising at least three of the first radioelectric positioning signals and a processing unit configured for determining the positioning information depending on the received geolocation signal.

2. Description of the Related Technology

Such a geolocation device is associated with a geolocation system by satellite, i.e., with a Global Navigation Satellite System (GNSS) system and is also called a geolocation GNSS device. The geolocation device is thus associated with a plurality of satellites which transmit to it the first radioelectric positioning signals. The geolocation device captures the first emitted positioning signals, for example by four satellites and is able by calculating the corresponding propagation times of the first signals between the satellites and the geolocation device, i.e., the distance which separates the geolocation device from the corresponding satellites. The geolocation device is then adapted for accurately locating its position according to three dimensions.

The geolocation device is desirably movable and is used both in civil and military fields. It is able to determine its geographic position, of locating this position on a field map and of transmitting the pieces of positioning information which it determines to various applications for example allowing determination of a route to be followed towards a given destination.

As a reminder, in GNSS systems, several satellites transmit the first radioelectric signals. Each first signal is obtained by modulation of a carrier by a so-called spreading code, to which are added data specific to the satellite emitting the first signal. The geolocation device, positioned on the position to be determined, captures the first signals by means of an antenna, and then performs processing of the first signals via the processing unit in order to determine its position.

One of the problems posed in geolocation systems, notably in the military field, is to neutralize the geolocation devices possessed by an opponent. Indeed, because of the low power of the first signals, jamming of the first signals is of particular interest. More generally, the goal is either to delude an opponent on his/her position and/or on the time which is available to him/her, via the emission of spoofing signals, or to deprive the opponent of information on his/her position and/or on the time, via the emission of jamming signals.

The use of high power jammers is thus known today, which emit, either jamming signals for which the frequency spectrum is similar to that of the first signals transmitted by the satellites and which give the possibility of depriving the opponent of information on his/her position and/or on the time, or spoofing signals, for which the characteristics are close to those of first signals transmitted by the satellites, but which comprise spoofing data.

However, such jammers are generally bulky, easily detectable and consume a significant amount of electric energy. Further, the coverage and the efficiency of such jammers is not homogenous on a given theater of operations.

### SUMMARY OF CERTAIN INVENTIVE ASPECTS

One objective of the described technology is to overcome the drawbacks described earlier by minimizing the energy consumed by the jammers and by improving the coverage of a theater of operations. Another objective is notably to improve the efficiency of the jammers.

For this purpose, one inventive aspect is an adapted geolocation device for receiving first radioelectric positioning signals from satellites, each first signal having a first frequency and being generated from a first code specific to the satellite from which stems the first signal, the device comprising a first antenna able to receive a geolocation signal desirably comprising at least three of the first signals from three different satellites, and a processing unit able to determine a piece of positioning information of the device depending on the geolocation signal which the first antenna is able to receive. The device also comprises a second antenna able to emit at least one second signal, each second signal either being an emitted jamming signal or an emitted spoofing signal and having a jamming or spoofing frequency spectrum comprising at least one of the first frequencies.

According to advantageous aspects of certain embodiments, the control method comprises one or several of the following features, taken individually or according to any technically acceptable combination:
the first frequencies are comprised in a predetermined frequency range, the device comprising a signal generation module able to generate at least one second signal having a second frequency below all the first frequencies, and a signal modification module able to modify the second generated signal so that the frequency of the second signal is equal to a third frequency comprised in the predetermined frequency range;
the device further comprises an anti-jamming module able to identify and suppress a received jamming signal and/or a received spoofing signal comprised in the geolocation signal which the first antenna is able to receive and a switching module movable between, a first position, in which the first antenna is electrically connected to the anti-jamming module and to the processing unit and, a second position, in which the second antenna is connected to the generation module;
each first signal has a first frequency spectrum and in which each second signal is an emitted jamming signal, the jamming frequency spectrum comprising at least one first frequency spectrum;
each first signal is obtained from an intermediate signal resulting from a combination of a data signal comprising data stored in memory by the satellite from which stems the first signal on the one hand and from which the processing unit determines the piece of positioning information, and the first code, on the other hand, and then by modulating a first carrier with the intermediate signal, each first code comprising the first code bits and having a first code frequency, and in which each second signal is an emitted spoofing signal generated from a second code, the second code comprising second code bits, similar to the first code bits of the first code of a corresponding first signal and a second code frequency equal to the first code frequency of the first code of the corresponding first signal;
the processing unit is adapted so as to determine a first phase of the first code of each first signal received by the first antenna, and wherein each second code has a second phase different from the first phase determined for the corresponding first signal;
the device comprises a member for determining spoofing data, different values of the data comprised in the data signal from which the corresponding first signal is obtained, each second signal comprising spoofing data;
the device further comprises a first module for selecting first signals for obtaining first selected signals, from which the processing unit is able to determine the piece of positioning information, and comprising at least one from among: a first recognition module able to identify the first codes of the first selected signals, each second signal being obtained from a second code different from the first identified codes, and a second recognition module able to identify the first frequency of the first selected signals, each second signal having a frequency different from the first identified frequencies;
the device comprises a controllable switch for selecting an operating mode of the jamming or spoofing device, the controllable switch being movable between a third position, in which each second signal is an emission jamming signal, and a fourth position, in which each second signal is an emission spoofing signal.

Another aspect is a set of geolocation devices in which the geolocation devices are as defined above.

### BRIEF DESCRIPTION OF THE DRAWINGS

The described technology will be better understood and other advantages of certain embodiments will become more clearly apparent upon reading the detailed description which follows, only given as a non-limiting example and made with reference to the appended figures wherein:
FIG. 1 is a schematic illustration of a geolocation device according to a first embodiment;
FIG. 2 is a schematic illustration of a geolocation device according to a second embodiment; and
FIG. 3 is a schematic illustration of a geolocation device according to a third embodiment.

### DETAILED DESCRIPTION OF CERTAIN INVENTIVE EMBODIMENTS

In a way known per se, the geolocation device 6 is adapted for receiving first radioelectric positioning signals S1 from satellites not shown. More specifically, the geolocation device 6 is able to receive a geolocation signal SG comprising at least three of the first radioelectric positioning signals S1 transmitted by three different satellites.

In some embodiments, the geolocation signal SG comprises four of the first radioelectric positioning signals S1, which allows the geolocation device 6 to determine a piece of positioning information, corresponding to its position in a three-dimensional reference system, and a clock error. Indeed, the geolocation device 6 comprises an internal clock which gives it the possibility of estimating a period close but not equivalent to a GNSS period, determined by the satellites, and more accurate. The clock error notably gives the possibility of refining the piece of positioning information of the geolocation device 6.

The first signals S1 each have a first respective frequency noted as F1. The first respective frequencies F1 are for example comprised in a predetermined frequency interval, for example, the interval [1 GHz; 1.6 GHz], or the interval [1.2 GHz; 1.5 GHz]. By definition, a quantity X belongs to the interval [Y; Z] if Y≦X≦Z. The predetermined frequency interval corresponds to an interval for which both limits correspond to a minimum frequency and to a maximum frequency for the first signals S1.

Each first radioelectric positioning signal S1 has a first frequency spectrum comprised in a first frequency interval, for example, [1.4 GHz; 1.6 GHz], or [1.45 GHz; 1.55 GHz].

More specifically, each first radioelectric signal S1 is obtained from an intermediate signal resulting from a combination between a data signal on the one hand and a first code specific to the satellite from which the first signal stems, on the other hand, and then by modulation of a first carrier with the intermediate signal. The combination corresponds to a modulo-2 addition of the first code and of the data signal. The modulation desirably corresponds to a phase modulation, the phase of the first carrier varying according to the amplitude values of the intermediate signal. The first carrier has the first frequency F1.

The data signal comprises data stored in memory by the satellite, from which stems the first signal S1, and from which the processing unit determines the piece of positioning information. In a known way, the first data are for example almanacs which give the positions of all the satellites of the constellation, over several weeks, with an accuracy of the order of 1 km and/or ephemerides, which give information on the position of the satellite from which the first signal S1 stems, with an accuracy of the order of 1 m to 10 m. The data signal has a throughput for example equal to 50 bit/s or to 125 bit/s.

The first code is a signal defined by first code bits, a first code frequency and a first phase. In other words, the first code comprises the first code bits and has a frequency equal to the first code frequency and a phase equal to the first phase. The first code frequency is for example equal to 1.023 MHz. In a known way, when the geolocation device receives one of the first signals, the geolocation device generates a local code corresponding to a replica of the first code and modifies the phase of the local code so that the local code follows the first received signal. The first phase is then equal to the phase of the local code and the geolocation device is able to calculate a phase lag experienced by the first received signal between its emission by the satellite and its reception by the geolocation device.

More generally, satellites for example in the case of a GPS system, permanently emit the first positioning signals S1 on a first high frequency of 1.5 GHz and on a first low frequency of 1.2 GHz. Thus, each satellite permanently emits a first high frequency signal, at the first high frequency of 1.5 GHz and a first low frequency signal at the first low frequency of 1.2 GHz and the geolocation device 6 is able to determine its position according to the first high frequency signal and/or the first low frequency signal.

The geolocation device 6 comprises a first antenna 8 for receiving the geolocation signal SG and a processing unit 10 configured for determining the position of the geolocation device 6 according to the received geolocation signal SG.

The geolocation device 6 comprises a module 12 for generating a signal, able to generate one or more second signals S2 corresponding to an emitted jamming signal of one or more other geolocation devices, so-called opponent devices, and a second antenna 8 for emitting second signals S2, in radioelectric form, towards the opponent geolocation devices. The second emission antenna 8 bears the same reference as the first receiving antenna 8, since they form a same global antenna 8.

The geolocation device 6 is thus, in a way known per se, able to determine its position on the one hand but also, to emit the emission jamming signal towards opponent geolocation devices on the other hand by means of the generation module 12 and of the global antenna 8.

The geolocation device 6 also comprises a switch 14 movable between a first position, in which the switch 14 electrically connects the global antenna 8 to the processing unit 10 and a second position in which the switch 14 electrically connects the global antenna 8 and the generation module 12. The switch 14 is able to be controlled at a given frequency so that it regularly passes from the first position to the second position and vice versa.

The geolocation device 6 comprises a casing B in which are positioned the processing unit 10, the generation module 12 and the switch 14. The geolocation device 6 is adapted so as to be of reduced size and transportable by a person or a vehicle. The geolocation device 6, as well as the casing B, for example has a volume of less than 4,000 cm³. The geolocation device thus allows for example radionavigation of a vehicle or of a person.

The first receiving antenna 8, i.e., the global antenna 8, is able to transmit the geolocation signal SG to the processing unit 10, via the switch 14.

The processing unit 10 comprises an analog pretreatment module 16, a digitization module 18 able to perform digitizing of the geolocation signal SG and a digital processing portion 19.

The generation module 12 comprises a generator 20 of the second signal S2 and a module 21 for modifying the second signals S2. More specifically, the generation module 12 is for example adapted so that the second generated signals S2 form the emission jamming signal, for which a jamming frequency spectrum includes the first frequency spectrum of one of the first signals or of several of the first signals, i.e., one of the first frequencies F1. The second signals S2 are thus able to jam the reception of the first signals received by the opponent geolocation devices which have their first frequency spectrum included in the jamming frequency spectrum.

In other words, the second emission antenna 8, i.e., the global antenna 8, is adapted for emitting the second signals S2, the second signals S2 corresponding or forming the emitted jamming signal, for which the jamming frequency spectrum comprises at least one of the first frequencies F1.

The generation module 12 and the global antenna 8 give the possibility of generating and emitting the emission jamming signal towards opponent geolocation devices, and thus depriving the opponent geolocation devices of information on their position and/or on their time.

The switch 14 according to the given frequency gives the possibility of alternatively controlling the emission of the jamming signal when it is in the second position on the one hand, and then, determining the position of the geolocation device 6 when it passes into the first position, on the other hand. The given frequency is for example comprised between 1 Hz and 2.77×10⁻⁴ Hz.

The analog pre-processing module 16 performs conversion into an intermediate frequency IF (Intermediate frequency). The geolocation signal SG, and therefore each first signal S1, is thus converted to the intermediate frequency via the analog pre-processing module 16. The pre-processing module 16 generally comprises filters and a local oscillator which allows conversion to the intermediate frequency.

The digitization module 18 is able to carry out digitization of the geolocation signal at the intermediate frequency and to provide a digitized signal to satellite digital processing channels, the channels being noted as Channel 1 to Channel S in FIG. 1. S represents the number of relevant satellites for determining the piece of positioning information. The digitization module 18 includes an automatic gain control module 22, the output of which is provided to the input of a digital/analog converter 24. Outputs of the digitization module 18 are used in the digital portion 19 of the geolocation device 6.

The digital portion 19 includes a module 26₁, 26₂, . . . 26_{S} for processing the digitized signal for each channel and a module 28 for calculating the position of the geolocation device 6. At the output of the calculation module 28, coordinates 30 of the position of the geolocation device 6 are obtained.

Each channel corresponds to one satellite, i.e., to a first carrier and to a first associated code. The first code may be assimilated to a coding key and more generally to a key for identifying the satellite to which it corresponds.

Each processing module 26₁, 26₂, . . . 26_{S} applies correlation modules, each correlation module being able to calculate an autocorrelation function ACF, the detection of a correlation peak in the ACF function gives the possibility of estimating, for each of the digital channels, a propagation delay, also called a phase lag, between the instant of emission by the corresponding satellite and the instant of reception by the geolocation device 6.

In a known way, each processing module 26₁, 26₂, . . . 26_{S} is associated with a satellite and more specifically with one of the first signals S1 at the first frequency F1 comprising the first corresponding code. Each processing module 26₁, 26₂, . . . 26_{S} comprises a Phase Locked Loop (PLL) loop which synchronizes the phase of a local carrier, generally locally, with the first carrier of the first received associated signal S1 and a Delay Lock Loop (DLL) loop which synchronizes a binary pseudo-random sequence, corresponding to a local code, generated locally and corresponding to the associated satellite, with the first code of the first received associated signal S1. More specifically, each processing module 26₁, 26₂, . . . 26_{S} comprises for the first signal S1 with which it is associated, at least one first member 31₁, 31₂, . . . 31_{S} for calculating the local carrier and at least one second member 32₁, 32₂, . . . 32_{S} for calculating the local code. The local code is similar to the first code comprised in the first signal S1 with which it is associated. In other words, the local code comprises local code bits similar to the first code bits comprised in the first corresponding signal S1 with which it is associated and a local code frequency similar to the first code frequency of the first corresponding signal S1. Further, synchronization of the local code with the first code gives the possibility of obtaining the local code with a phase equal to the first phase. Each processing module 26₁, 26₂, . . . 26_{S} provides in a known way, for the associated satellite channel, the phase of the first carrier and the phase of the first code at the output of the loops described above.

The calculation module 28 is able to determine the distance between the geolocation device 6 and each satellite notably depending on the data comprised in the data signal of the first signal S1 associated with the satellite and on the propagation delays estimated by the processing module 26₁, 26₂, . . . 26_{S} associated with the satellite, i.e., notably phases of the first carrier and of the first code provided by the processing module 26₁, 26₂, . . . 26_{S} associated with the satellite. The calculation module 28 is thus able to calculate the position of the geolocation device 6 according to the determined distances.

The generator 20 of the second signals S2 is able to generate the second signals S2 at a second frequency F2 below all the first frequencies F1. The second frequency is desirably equal to the intermediate frequency. The generator 20 ensures generation of the second signals S2 at the second frequency and for example comprises a memory 36 able to store in memory the second signals S2, and a conversion member 38. The conversion member 38 includes an analog/digital converter 40 and an automatic gain control module 42. The gain control module 42 is connected at the output to the modification module 21.

The module 21 for modifying the second signals S2 is adapted so that the second signals S2 have a third frequency F3 comprised in the predetermined frequency range. The modification module 21 carries out conversion of the frequency of the second signals S2 from the second frequency F2 to the third frequency F3. Advantageously, the modification module 21 is adapted for using the same local oscillator as the one of the analog pre-processing module 16. At the output of the modification module, the second signals correspond to the emission jamming signal, i.e., form the emission jamming signal for which the jamming frequency spectrum includes the first frequency spectrum of one of the first signals, i.e., one of the first frequencies F1.

Alternatively, the switch 14 is replaced with a device of the circulator type connected to the processing unit 10, to the generation module 12 and to the global antenna 8 and adapted for transmitting the geolocation signal SG from the global antenna 8 to the processing unit 10 and for transmitting the second signals S2 from the generation module 12 towards the global antenna 8.

In a second embodiment, shown in FIG. 2, the elements similar to those of the first embodiment bear the same references. Subsequently, only the differences between the first and the second embodiments will be shown and similar elements will not be described again.

Thus, in the second embodiment, the geolocation device 6 is adapted for generating second signals S2 corresponding to an emitted spoofing signal from the first 31₁, 31₂, . . . 31_{S} and second 32₁, 32₂, . . . 32_{S} calculation members of the processing modules 26₁, 26₂, . . . 26_{S}.

The generation module 12 comprises a member or module 44 for determining spoofing data. Spoofing data are able to be integrated into the second signals S2 and are determined so that the position and/or the time determined by the opponent geolocation devices, via the second signals S2, are erroneous and that the calculations carried out by the latter are erroneous. Advantageously, the spoofing data have different values of the data comprised in the data signal from which the first signal 51, for which one wishes to emit a decoy, is generated.

The generation module 12 is therefore able to generate emission of the spoofing signal from the first 31₁, 31₂, . . . 31_{S} and second 32₁, 32₂, . . . 32_{S} calculation members and from spoofing data. In other words, the second antenna 8, i.e., the global antenna 8, is able to emit second signals S2, which correspond to the spoofing signal emitted towards opponent geolocation devices. More specifically, each second signal S2 has, by means of the use of the first calculation members 31₁, 31₂, . . . 31_{S}, and of the modification module 21, a third frequency F3 equal to the first frequency F 1 of one of the first signals for which one wishes to emit a decoy. In other words, the second signal S2 has a spoofing frequency spectrum which comprises at least one the first frequencies F1.

Further, by using the second calculation members 32₁, 32₂, . . . 32_{S}, each second signal S2 is generated from a second code, obtained from the local code. The second code therefore comprises second code bits similar to the first code bits of the first code of a corresponding first signal S1, for which one wishes to emit a decoy and a second code frequency equal to the first code frequency of the corresponding first signal S1. This gives the possibility of deluding the opponent geolocation devices on their actual position.

Advantageously, the processing unit 10 and more specifically the processing modules 26₁, 26₂, . . . 26_{S}, are adapted for determining a first phase of the first code of each first signal S1 and each second code has a second phase different from the first phase of the corresponding first signal S1.

In the second embodiment, the memory 36 is replaced with a third calculation member 46 able to carry out modulation of the local carriers and of the local codes associated with satellites, i.e., with first signals S1, for which one wishes to emit a decoy. The third calculation member 46 is therefore able to generate the second signals S2 corresponding to the emitted spoofing signal. The third calculation member 46 comprises at the input the local codes and the local carriers determined by the first 31₁, 31₂, . . . 31_{S} and second 32₁, 32₂, . . . 32_{S} calculation members, as well as the spoofing data determined by the determination member 44. The third calculation member 46 is configured for selecting the local carriers and the local codes corresponding to the satellites for which one wishes to emit a decoy and for calculating the second signals from the modulation of each local carrier selected by the corresponding selected local code, to which spoofing data are added. The results of the different modulations carried out are able to be transmitted to the conversion member 38.

By generating the second signals from the first 31₁, 31₂, . . . 31_{S} and second 32₁, 32₂, . . . 32_{S} calculation members, it is possible to guarantee that the characteristics of the emitted spoofing signal, i.e., for example that the second code bits of the second signals S2 and the frequency of the second signals S2 which form it, are as close as possible to the first signals transmitted by the satellites for which one wishes to emit a decoy and thus optimize chances of success of the decoy.

Advantageously, the first and second embodiments are combined together within a same geolocation device. The geolocation device then comprises a switch controllable by an operator and allowing selection of a mode for jamming operation of the device, corresponding to the operation according to the first embodiment, or a mode for operating with a decoy, corresponding to the second embodiment. The controllable switch is movable between a third and a fourth position. Thus, the geolocation device resulting from this combination is able to transmit the emission jamming signal when the switch is in the third position and the emission spoofing signal when the switch is in the fourth position.

Alternatively, the first and second embodiments are combined together within a same geolocation device and the generator 20 of the second signals S2 is able to generate several second signals with, at least one second signal which is an emitted spoofing signal and at least one second signal which is an emitted jamming signal. The emitted spoofing signal and the emitted jamming signal in this alternative have different frequencies and distinct frequency spectra.

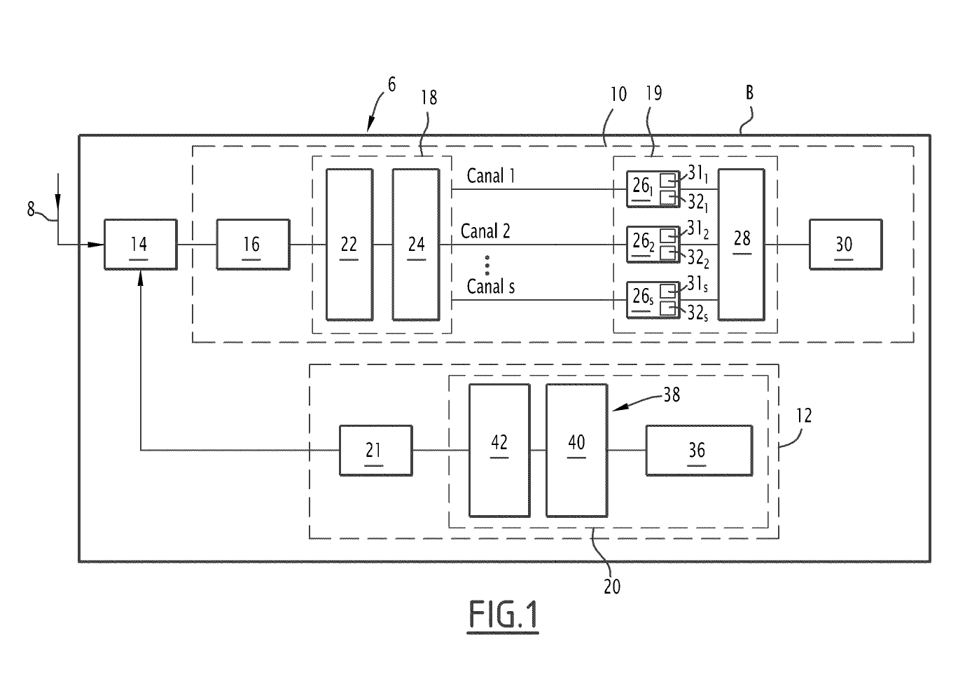

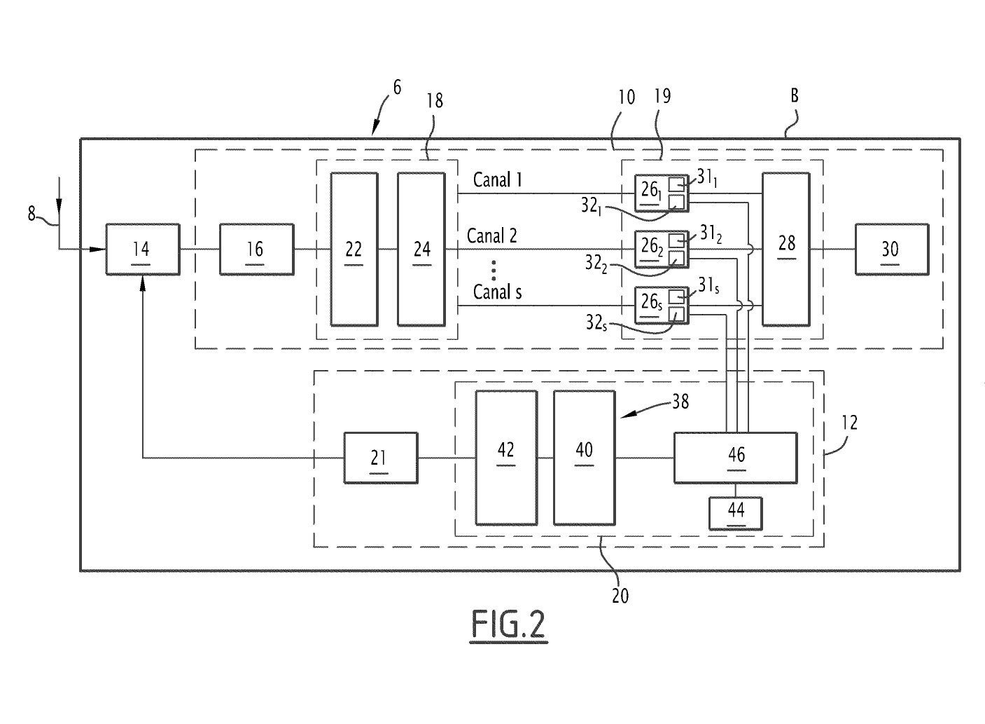

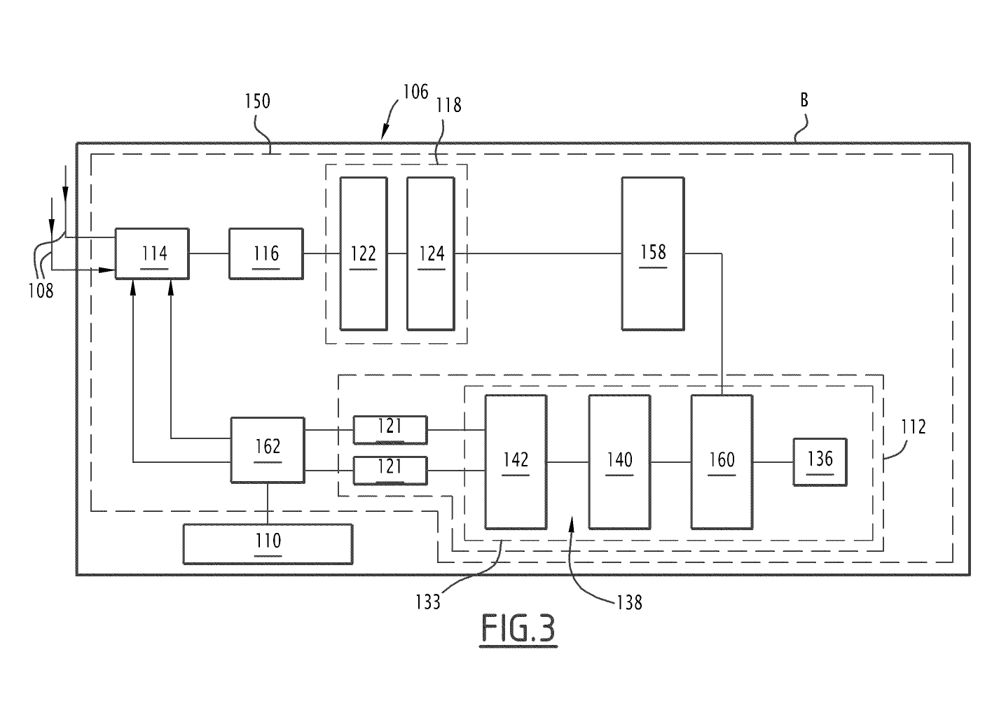

In a third embodiment, shown in FIG. 3, the elements similar to those of the first embodiment bear the same references increased by a 100. The differences between the first and third embodiments will be shown subsequently and the similar elements between the first and third embodiment will not be described again.

In the third embodiment, the geolocation device 106 comprises several global antennas 108, a processing unit 110 and an anti-jamming module 150.

The global antennas 108 form both the first antennas for receiving the first signals S1 and the second antennas for emitting second signals S2. The global antennas 108 are electrically connected to the anti-jamming module 150.

The anti-jamming module 150 is adapted, in a way known per se, for suppressing a received jamming signal and/or a received spoofing signal comprised in the geolocation signal received by the global antennas 108.

The anti-jamming module 150 is positioned upstream from the processing unit 110. The anti-jamming module 150 comprises a preprocessing module 116, a digitization module 118 and an identification unit 158.

The anti-jamming module 150 also comprises a module 112 for generating second signals S2, a first switch 114, a second switch 160 and a third switch 162. The anti-jamming module is therefore adapted for generating the second signals S2 which correspond, in the case of the third embodiment, to the emission jamming signal. The anti-jamming module 150 therefore in addition to its primary anti-jamming function fulfills a function for jamming opponent receivers. Thus, the geolocation device 106 is adapted for determining its position, by means of the processing unit 110 and this reliably, by means of the anti-jamming module 150. Further, the geolocation device 106 is also able to emit the emission jamming signal.

The generation module 112 is able to generate the second signals, corresponding to the emission jamming signal. The global antennas 108 are therefore able to emit the second signals and thus emit the emission jamming signal. The generation module 112 comprises a generator 133 and modification modules 121.

The first switch 114 is positioned between the global antennas 108 and the preprocessing module 116. The first switch 114 is movable between a first position, in which the first switch 114 electrically connects the global antennas 108 to the identification unit 158 and a second position, in which the first switch 114 electrically connects the global antennas 108 and the generation module 112.

The digitization module 118 includes an automatic gain control module 120, the output of which is provided at the input of an analog/digital converter 122.

Outputs of the digitization module 118 are used by the identification unit 158 which is adapted for identifying and suppressing a received jamming signal and/or a received spoofing signal comprised in the geolocation signal SG received by the global antennas 108.

The generator 133 for example includes a memory 136 able to store in memory the second signals, i.e., store memory samples corresponding to the second signals, and a conversion member 138. The conversion member 138 includes a digital/analog converter 140 and an automatic gain control module 142. The gain control module 142 is connected to the output of the modification modules 121.

Each modification module 121 is able to be associated, i.e., connected with one of the global antennas 108. The modification modules 121 each receive the second signals S2 generated by the generator 133 and are each able to modify the level of the second signal(s) S2 differently in order to orient the emission direction of the second signal(s) by the global antennas 108.

The second switch 160 is connected to the identification unit 158 and to the memory 136 on the one hand and to the conversion member 138 on the other hand. The second switch 160 is movable between a fifth position in which it electrically connects the identification unit 158 to the conversion member 138 and a sixth position in which it electrically connects the memory 136 to the conversion member 138.

The third switch 162 is connected, on the one hand, to the modification module 121 and secondly, to the processing unit 110 and the first switch 114.

The third switch 162 is movable between a seventh position in which it electrically connects the generation module 112 of the first switching device 114 and an eighth position in which it electrically connects the generation module 112 to the processing unit 110.

The first 114, second 160 and third 162 switches form a switching module movable between a first global position and a second global position. In the first global position, the switching module electrically connects the global antennas 108 to the identification unit 158 and the identification unit 158 to the processing unit 110, so that the processing unit receives the geolocation signal SG and determines the position of the geolocation device 106. In other words, in the first global position, the switching module electrically connects the global antennas 108 to the anti-jamming module 150 and to the processing unit 110. In the second global position, the switching module electrically connects the generation module 112, notably the memory 136, to the global antennas 108 in order to emit the emission jamming signal.

The geolocation devices 6, 106 according to the first and third embodiments generally allow generation and transmission of the emission jamming signal, i.e., more generally jamming signals towards the opponent receivers in order to deprive the opponent of information on its position and/or on the time which it has. Indeed, they are adapted for transmitting second signals, the jamming frequency spectrum of which includes the first frequency spectrum of one or several of the first signals.

Moreover, the geolocation device 6, according to the second embodiment, generally allows transmission of the emitted spoofing signal, i.e., more generally spoofing signals, towards opponent geolocation devices for deceiving the opponent on its position and/or on the time which it has. Indeed, it generates second signals, the characteristics of which are close to those of certain first signals, but which comprise spoofing data.

The geolocation devices 6, 106 according to the three embodiments, both provide a capability of determining the position of the geolocation device and a jamming and/or spoofing capability. The geolocation devices 6, 106 are thus configured for fulfilling two functions and integrate means for transmitting second signal(s) to other geolocation devices. The second signal(s) form(s) the emission jamming signal and/or the emission spoofing signal and because of the abundance of the number of geolocation devices 6, 106 on a theater of operations, for example a military theater, the geolocation devices 6, 106 provide significant jamming and spoofing capabilities, as well as coverage of the theater of operations and optimized efficiency. Further, as the geolocation devices 6, 106 are numerous, they are intended to be of low power, which limits their consumption and makes their detection more difficult for a possible opponent.

The geolocation devices 6, 106 generally form a set of geolocation devices adapted for jamming and/or deceiving opponent geolocation devices in an efficient way.

Advantageously, in the three embodiments, the geolocation device transmits to so-called friend geolocation devices, pieces of information relating to a shape of the second signal S2 and/or to an emission frequency or period of the second signal S2. The so-called friend geolocation devices are then able to carry out adaptive time or frequency filtering for ignoring the second signals S2.

Alternatively, not shown, in the first and third embodiments, the geolocation devices 6, 106 allow generation of a spoofing signal. In this alternative, the generation module 12, 112 comprises a first member for calculating at least one second carrier and a second calculation member for at least one second code comprising bits identical with those of the first code of a corresponding first signal. The generation module 12 is then adapted for generating the second signal(s) S2 from the modulation of the second carrier(s) with the second code(s), so that the second signal(s) have the same frequency F3, being aware that the third frequency F3 is globally similar to the first frequency F1 of the corresponding first positioning signal. In this alternative, the generation module 12 also comprises a member for determining spoofing data for each second signal. The generation module is then adapted for generating the second signal(s) from spoofing data, from the second carrier(s) and from the second code(s). The second signal(s) correspond(s) then to the emission spoofing signal.

According to another alternative, in the three embodiments, the geolocation device 6, 106 comprises a first module for selecting first signals S1 in order to obtain the selected first signals. The processing unit 10, 110 is then able to determine the piece of positioning information from the first selected signals. In this alternative, the geolocation device 6, 106 either comprises, in a first case, a first recognition module able to identify the first codes of the first selected signals S1, or, in a second case, a second recognition module able to identify the first frequency of the selected first signals S1.

In the first case, the generation module 12, 112 calculates each second signal S2 from a second code different from the first codes corresponding to the selected first signals. In other words, each second signal S2 is obtained from a second code comprising the second code bits different from the code bits of the first identified codes. This gives the possibility of guaranteeing that the first signals S1 for which the corresponding spoofing signal is transmitted, are not used by the geolocation device 6, 106 for determining its position.

In the second case, each second signal S2 calculated by the generation module 12, 112 has a frequency different from the first identified frequency. In this alternative, the first selection module is for example configured for selecting the first signals having a first frequency equal to 1.5 GHz, i.e., the preprocessing module is adapted for carrying out filtering and recovering the first signals for which the frequency is equal to 1.5 GHz. The generation module 12, 112 then for example calculates each second signal S2 so that each second signal has a frequency, different from 1.5 GHz, for example equal to 1.2 GHz. This gives the possibility of guaranteeing that the first signals for which the emitted spoofing signal or the corresponding emitted jamming signal are transmitted, are not used by the geolocation device 6, 106 for determining its position. Further, the fact that the frequencies of the first and second signals are different gives the possibility, following the setting up of adapted filtering, for example at the global antenna(s) 8, 108, of simultaneously carrying out reception of the first signals and emission of the second signals.

According to another alternative, in the three embodiments shown above, the geolocation device 6, 106 comprises one or first reception antennas and one or second emission antennas which are different. The geolocation device 6, 106 is thus adapted for simultaneously transmitting the second signal(s) in radioelectric form and receiving the geolocation signal, since the geolocation device 6, 106 comprises antennas dedicated to receiving the first signals and antennas dedicated to emitting the second signals.

The embodiments and alternatives described above may be combined with each other, totally or partly, in order to give rise to other embodiments.

As can be appreciated by one of ordinary skill in the art, each of the modules or software of the program(s) can include various sub-routines, procedures, definitional statements, and macros. Each of the modules are typically separately compiled and linked into a single executable program. Therefore, any description of modules or software is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware such as a processor circuit or the processing unit 10.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein the instructions perform some or all of the steps of the above-described methods. The program storage devices may be, e.g., digital memories, magnetic storage media such as a magnetic disks and magnetic tapes, hard drives, or optically readable digital data storage media. The embodiments are also intended to cover computers programmed to perform the steps of the above-described methods.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A geolocation device adapted for receiving a plurality of first radioelectric positioning signals from a plurality of corresponding satellites, each first signal having a first frequency and being generated from a first code specific to the corresponding satellite, from which the first signal stems, the device comprising:
a first antenna configured to receive a geolocation signal;
a processing unit configured to determine a piece of positioning information of the device depending on the geolocation signal which the first antenna is configured to receive; and
a second antenna configured to emit at least one second signal, the second signal being either: i) an emitted jamming signal, or ii) an emitted spoofing signal and having a jamming or spoofing frequency spectrum comprising at least one of the first frequencies.

2. The device according to claim 1, wherein the first frequencies are comprised in a predetermined frequency range, the device further comprising:
a signal generation module configured to generate the at least one second signal having a second frequency below all the first frequencies; and
a signal modification module configured to modify the generated second signal so that the frequency of the second signal is equal to a third frequency comprised in the predetermined frequency range.

3. The device according to claim 2, further comprising:
an anti-jamming module configured to identify and suppress a received jamming signal and/or a received spoofing signal comprised in the geolocation signal which the first antenna is able to receive; and
a switching module movable between: i) a first position, in which the first antenna is electrically connected to the anti-jamming module and to the processing unit and, ii) a second position, in which the second antenna is connected to the generation module.

4. The device according to claim 1, wherein each of the first signals has a first frequency spectrum and in which each of the second signals is an emitted jamming signal, each of the jamming frequency spectrums comprising at least one of the first frequency spectrums.

5. The device according to claim 1, wherein each of the first signals is obtained from an intermediate signal resulting from a combination between: i) a data signal comprising data stored in a memory by the satellite from which stems the first signal and from which the processing unit determines the piece of positioning information, and ii) the first code, and then by modulation of a first carrier by the intermediate signal, wherein each first code comprises the first code bits and has a first code frequency, and in which each second signal is an emitted spoofing signal, generated from a second code, wherein the second code comprises second code bits similar to the first code bits of the first code of a first corresponding signal and a second code frequency equal to the first code frequency of the first code of the first corresponding signal.

6. The device according to claim 5, wherein the processing unit is adapted for determining a first phase of the first code of each first signal received by the first antenna, and in which each second code has a second phase different from the first phase determined for the corresponding first signal.

7. The device according to claim 5, further comprising a member for determining spoofing data with different values of the data comprised in the data signal from which the first corresponding signal is obtained, each second signal comprising spoofing data.

8. The device according to claim 1, further comprising a first module for selecting first signals in order to obtain selected first signals, from which the processing unit is configured to determine the piece of positioning information, and comprising at least one of the following:
a first recognition module configured to identify the first codes of the selected first signals, each second signal being obtained from a second code different from the first identified codes, and
a second recognition module configured to identify the first frequency of the selected first signals, each second signal having a frequency different from the first identified frequencies.

9. The device according to claim 1, further comprising a controllable switch for selecting an operating mode of the jamming or spoofing device, the controllable switch being movable between a third position, in which each second signal is an emitted jamming signal and, a fourth position, in which each second signal is an emitted spoofing signal.

10. A set of geolocation devices, wherein the geolocation devices are all according to claim 1.
